(19) United States
(12) Patent Application Publication
(10) Pub. No.: US 2021/0095736 A1
(43) Pub. Date: Apr. 1, 2021

(54) CYLINDRICAL DIAPHRAGM ASSEMBLY WITH REDUCED DIAMETER FOR HIDRAULIC SHOCK ABSORBERS SEALED AT BOTH ENDS, OF THE TYPE EMPLOYED IN SELF-CLOSING FURNITURE

(71) Applicant: INDUSTRIAS AUXILIARES, S.A., GETARIA, GIPUZKOA (ES)

(72) Inventor: Luis Maria RIOJA IRIBARREN, GETARIA, GIPUZKOA (ES)

(21) Appl. No.: 16/765,399

(22) PCT Filed: Oct. 11, 2019
(86) PCT No.: PCT/ES2019/070692

§ 371 Date: May 19, 2020

(30) Foreign Application Priority Data
Dec. 21, 2018 (ES) P201831265

(51) Int. Cl. F16F 9/32; F16F 9/36

(52) U.S. Cl. CPC F16F 9/3207; B60G 2202/24; F16F 9/36

(57) ABSTRACT

Cylindrical diaphragm assembly of reduced diameter for hydraulic shock absorbers with sealing at both ends, of those used in self-closing furniture, which at its outer end performs the sealing of the cylindrical body of the shock absorber and at its inner end performs the sealing of the shock absorber shaft, said cylindrical diaphragm assembly being on its outer side a fluid compensation chamber and on the other inner side an aerial chamber and consisting of an insertable elastic hood whose inner end has an annular decrease in diameter, generating a flat support area and ending in a conical extension of a simple seal in contact with the axis of the shock absorber, and of an inner tubular centering male provided at its inner end with a conical head with a flat outer wall for support and fixing of said insertable elastic hood; and that said inner tubular centering male has longitudinal flaps, said inner tubular centering male ending in a closure plug prominence which, with the outer end of the insertable elastic hood, generates a simple seal with the cylindrical body of the shock absorber.

### FIELD OF THE INVENTION

This invention relates to a cylindrical diaphragm assembly with reduced diameter for hydraulic shock absorbers sealed at both ends, of the type employed in self-closing furniture. Of the type used in shock absorbers to seal both the passage of liquid at the outer sealing end of the cylindrical body of the shock absorber, and to seal the passage of liquid at the inner sealing end of the shock absorber shaft, and that these shock absorbers also contain shaft volume compensators, due to the volume occupied by said shaft inside the shock absorber body.

It is important to consider that the reduced dimensions of these shock absorbers make it critical to adopt more complicated configurations.

### STATE OF THE ART

At present and as a reference to the state of the art, the use of diaphragms acting both to seal at the external contact end with the shock absorber cylinder and to seal at the inner contact end with the shock absorber shaft is known. The seals used at the ends prevent the fluid from leaving the inner chamber of the shock absorber cylinder, both through the end of the body and the axis, and incorporating different systems for the compensation of the volume of liquid displaced due to the volume of axis introduced in the body of the shock absorber, which influences the capacity of the chambers.

There is a type of solution for compensating the volume of the shaft immersed in the fluid containing the shock absorber, based on longitudinally-displaceable seals with the aid of a spring that allow the chamber storing the fluid to increase or decrease, compensating the volume variation due to the axis. These solutions imply that the sealing of the outer body ceases to be static, as is usual, and becomes mobile. This implies that the sealing is more critical due to consequent wear. In addition, the spring generates the undesirable residual pressure effect, which, as with the sponges, tries to move the shaft outwards.

Another solution adopted in shock absorbers that is more common in the automobile sector, is the use of a diaphragm mounted at the ends of a bushing mounted between the shaft and the cylindrical body of the shock absorber, said bushing being at its inner end in the form of a cup and the diaphragm acting as a seal at the ends of said bushing. Said diaphragm is coupled to the cup-shaped end of the bushing so that said cup is enclosed, folding back to produce the sealing of the cylinder shaft producing a double lip seal. However, with use and backward bending, this solution leads to the rupture or permanent deformation of the diaphragm with the consequent reduction of the sealing, making the compensation of the shock absorber less effective. In addition, in the case of self-closing furniture in which the diameters of these shock absorbers have very small dimensions, this solution would not be viable due to the difficulty in its manufacture and its assembly for such small dimensions.

Other solutions also employ bushings or tubular elements at the two ends of the bushing, resulting in sealing with the shock absorber cylinder at its outer end, but requiring an additional seal or several additional elements for sealing with the shock absorber shaft.

Another common solution in cars is the use of two pistons between which there is a tubular bushing that fixes a compensation diaphragm at its two ends. However, this arrangement, despite setting a compensation distance, does not allow a homogeneous deformation of the diaphragm and therefore requires trocoidal diaphragm designs with radial thickness variation to reduce the stress borne by the diaphragm during the shock absorber operation and thus avoid the formation of folds of a small radius that shorten its useful life, being the most complicated and expensive manufacturing. And since the elastic work of the perimeter of the diaphragm is mostly assumed by the valleys of said trocoidal section that are segments of lesser thickness, therefore this solution only takes advantage of half of the elastic deformation capacity of the diaphragm.

### Explanation of the Invention and Advantages

Faced with this state of the art, the present invention refers to a cylindrical diaphragm assembly of reduced diameter for hydraulic shock absorbers with sealing at its two ends, of the type used in self-closing furniture, which at its outer end performs the sealing of the cylindrical body of the shock absorber and at its inner end performs the sealing of the axis of the shock absorber, said cylindrical diaphragm assembly being on its outer side a fluid compensation chamber and on the other inner side an aerial chamber, and having an insertable elastic hood whose inner end has an annular decrease in diameter, generating a flat support area and ending in a conical extension of a simple seal in contact with the axis of the shock absorber, and acting in conjunction with a central male tubular centering having in its inner end a flat-walled tapered head with an outer support and fixation of said insertable elastic hood; and that said male inner tubular centering has longitudinal flaps ending in a closure cap prominence, which, with the outer end of the insertable elastic hood, generates a simple seal with the cylindrical body of the shock absorber.

Thanks to this configuration, it is possible to compensate for the volume of the shaft submerged in the fluid (usually oil) during the insertion maneuver of said shaft into the body of the shock absorber, using a simple seal with the shaft and also reducing the number of elements necessary to perform this task. In addition, this solution makes it possible to manufacture diaphragm assemblies for smaller dimensions, necessary in self-closing furniture shock absorbers, which are very different from the solutions already known in the automobile and large machinery sector. Thus, for the automobile sector, the standard minimum for the inside diameter of the cylindrical body of the shock absorber is of the order of millimeters, while, for self-closing furniture, diameters of the order of 6 millimeters are customary, and allow a smaller number of elements to be used.

With the use of an inner tubular centering male and an insertable elastic hood, the assemblage of the assembly is facilitated prior to its insertion into the cylinder of the shock absorber, and, due to its configuration only with the insertion of the elastic hood in the inner tubular centering male, the cylindrical diaphragm assembly remains centred and fixed without the need for additional maneuvers for assembly or additional elements for sealing.

With regard to the internal end, and due to its configuration with an annular decrease in diameter ending in a truncated conical extension, a simple seal is generated in the inner zone of contact with the shaft, enabling the operation of the elasticity of the diaphragm that eliminates edges generating critical areas of fatigue that may cause permanent breakage or deformation of the elastic element, as is the case with inwardly folded seals or double-lip configurations.

In addition, the flat-walled tapered head of the central tubular centering male allows fixing in the inner end of the insertable elastic hood, thus preventing it from moving in compression during the movement of the shock absorber shaft, as can be the case in other embodiments in which said internal end of the diaphragm is not fixed and produces displacements that reduce the tightness and, therefore, the lower effectiveness in shock absorbering. In addition, with the help of the longitudinal flaps of the inner tubular centering male, the assembly is facilitated by centering the diaphragm assembly and ensuring that the insertable elastic hood has a controlled deformation and is as smooth and distributed as possible, without critical areas of extreme flexion that end up breaking down due to fatigue and therefore causing oil leaks and ensuring balance in the flexion of the insertable elastic hood.

Another advantage of the configuration with longitudinal flaps of the inner tubular centering male, is that they facilitate a greater compensation surface, since said longitudinal flaps force the inner annular surface of the insertable elastic hood to have a controlled deformation along its entire perimeter and, therefore, take advantage of all the deformation capacity in a controlled manner, unlike other embodiments in which the trochoidal configuration of the section of the elastic element forces it to deform along the section segments of smaller thickness, thus reducing the elastic deformability, and, in this manner, it is more complicated to control the compensation.

Another feature of the invention is that the top of the longitudinal flaps of the centering tubular inner male is rounded. This allows a smoother deformation if possible, avoiding critical edges that can cause breakage or malfunction of the cylindrical diaphragm assembly.

Another particular feature of the invention is that the longitudinal flaps are peripherally symmetrical in distribution, evenly compensating the elastic stresses to which the insertable elastic hood, deformable in use, is subjected. Thanks to this configuration, the inner tubular centering male is more robust and resistant, improving the strength and durability of the cylindrical diaphragm assembly and allowing a more-controlled and distributed deformation of the insertable elastic hood for compensation without critical fatigue areas.

According to the invention, it is provided that at least one window of atmospheric communication with the outside exists in the tubular part of the outer end of the inner tubular centering male.

Thanks to this configuration of the invention, compensation of the volume of the shaft submerged in the inner fluid of the shock absorber is obtained, providing zero residual antagonistic stress, because the increase in compression pressure of the air inside the fluid compensation annular chamber is avoided, when the shock absorber shaft is inserted.

Another feature of the invention is that it is provided that the outer annular surface of the insertable elastic hood incorporates longitudinal evacuation striations of reduced depth.

Thanks to this configuration, the assembly of the shock absorber is facilitated by evacuating the volume of air that will be occupied by the double sealing gasket inside the cylindrical body of the shock absorber. This air will go out through the longitudinal striations of evacuation towards the outside, avoiding the creation of air pockets. The shock absorbers used in furniture elements are characterised by being small in size, so it is necessary to facilitate and simplify as far as possible the assembly of its elements.

Likewise, it is provided in an alternative embodiment that the insertable elastic hood, on its inner annular surface, incorporates circularly symmetrical positioning ribs radially in the direction of the shock absorber shaft and with its end close to the surface of the shock absorber shaft.

This configuration, with the existence of the emerging positioning ribs from the inner annular surface of the insertable elastic hood, replacing the longitudinal flaps of the centering tubular inner core, guarantees a correct functioning of the diaphragm assembly, avoiding the displacement of the inner shaft sealing end when said shock absorber shaft is immersed in the fluid that contains the shock absorber cylinder.

Likewise, possible displacements of the internal shaft sealing end are avoided due to the turbulent oil flows produced when the acceleration provided to said shock absorber shaft is excessively high and ensures the elimination of fatigue points in the elastic activation of the insertable elastic hood.

### DRAWINGS AND REFERENCES

To better understand the nature of the invention, the attached drawings represent an industrial embodiment that is merely illustrative and not limiting.

FIG. 1 shows an exploded view of the cylindrical diaphragm assembly for shock absorbers (1) where the arrow indicates the direction of insertion in the assembly of the insertable elastic hood (2) in the centering tubular inner core (3). With section details of the inner end of both components where you can see its configuration.

FIGS. 2 and 3 are longitudinal section views of the inner tubular centering male (3) and the insertable elastic hood (2) respectively. Where the arrow also indicates the direction of insertion in the assembly of the cylindrical diaphragm assembly for shock absorbers (1).

FIG. 4 shows a section view of the cylindrical diaphragm assembly (1) already assembled.

FIG. 5 shows a scale comparison of the difference in size of the shock absorber (4) of the present invention with the minimum internal diameter of the cylindrical body of the shock absorber (8), compared to a self-absorbing shock absorber of automobiles or large machinery with its minimum diameter inside the cylindrical body of the shock absorber (8).

FIG. 6a shows a section view of the cylindrical diaphragm assembly (1) mounted on the shock absorber (4) and with the shock absorber shaft (9) extended to the maximum, where the arrows indicate the air outlet of the aerial chamber (14) to the exterior.

FIG. 6b shows a longitudinal section view of the shock absorber (4) with the shock absorber shaft (9) extended to the maximum.

FIG. 6c shows a cross-section view A-A indicated in FIG. 6b, in which the configuration of the insertable elastic hood (2) with the maximum volume of air inside the aerial chamber (14) is observed.

FIG. 7a shows a section view of the cylindrical diaphragm assembly (1) mounted on the shock absorber (4) and with the axis of the shock absorber (9) introduced to the maximum in the 8 shock absorber cylindrical body (8), and wherein the aerial chamber is observed (14) with the smallest volume of air inside, due to the volume of fluid displaced.

FIG. 7b shows a longitudinal section view of the shock absorber (4) with the shock absorber shaft (9) inserted to the maximum.

FIG. 7c shows a cross-section view B-B indicated in FIG. 7b, in which the configuration of the insertable elastic hood (2) with the minimum volume of air inside the aerial chamber (14) is observed.

FIG. 8a shows an elevation view of the inner tubular centering male (3) and FIG. 8b a cross-section view C-C of FIG. 8 where the configuration of the longitudinal flaps (12) is seen.

FIG. 9a shows a longitudinal section view of the shock absorber (4) with the shock absorber shaft (9) extended to the maximum, in an alternative embodiment, with the insertable elastic hood (2) having positioning ribs (22), in the which the aerial chamber (14) is observed with the largest volume of air inside.

FIG. 9b shows in profile the section A-A indicated in FIG. 9a, in which the configuration of the insertable elastic hood (2) is observed, for the execution with positioning ribs (22), with the maximum volume of air in the interior of the aerial chamber (14).

FIG. 10a shows a longitudinal section view of the shock absorber (4) with the shock absorber shaft (9) maximally inserted into the cylindrical body of the shock absorber (8), which has positioning ribs (22), in which the aerial chamber (14) is observed with the smallest volume of air inside, due to the volume of fluid displaced.

FIG. 10b shows in profile the section B-B indicated in FIG. 10a, in which the configuration of the insertable elastic hood (2) is observed, for the execution with positioning ribs (22), with the minimum volume of air in the interior of the aerial chamber (14).

In these figures, the following references are indicated:
1.—Cylindrical diaphragm assembly for reduced diameters
2.—Insertable elastic hood
3.—Tubular centering center male
4.—Shock absorber
5.—Internal end of the insertable elastic hood (2)
6.—Flat support area of the insertable elastic hood (2)
7.—Truncated conical extension of a simple elastic insertable hood seal (2)
8.—Cylindrical body of the shock absorber (4)
9.—Shaft of the shock absorber
10.—Trunk conical head
11.—Flat outer support wall
12.—Longitudinal flaps
13.—Fluid compensation chamber
14.—Aerial chamber
15.—Prominence of closure cap
16.—External end of the insertable elastic hood (2)
17.—Top of the longitudinal flap (12)
18.—Window of atmospheric communication with the outside
19.—Longitudinal striations of evacuation
20.—Exterior annular surface of the insertable elastic hood (2)
21.—Interior annular surface of the insertable elastic hood (2)
22.—Positioning ribs
22a.—Positioning nerve end (22)

### EXHIBITION OF A PREFERRED EMBODIMENT

In relation to the drawings and references listed above, a preferred mode of execution of the object of the invention, referring to a cylindrical diaphragm assembly of reduced diameter for hydraulic shock absorbers with sealing at its two ends, of those used in self-closing furniture, which at its outer end performs the sealing of the cylindrical body of the shock absorber (8) and in its inner end performs the sealing of the shock absorber shaft (9), said cylindrical diaphragm assembly (1) being on its outer side a fluid compensation chamber (13) and on the other inner side an aerial chamber (14) characterised in that it has of an insertable elastic hood (2) whose inner end (5) has an annular decrease in diameter, generating a flat support area (6) and ending in a conical extension of a simple seal (7) in contact with the axis of the shock absorber (9), and acting in conjunction with an inner tubular centering male (3) provided at its inner end with a conical head (10) with a flat wall outer support and fixing (11) of said insertable elastic hood (2); and that said inner tubular centering male (3) has longitudinal flaps (12) ending said inner tubular centering male (3) in a closure cap prominence (15) which, with the outer end (16) of the insertable elastic hood (2), generates a simple seal with the cylindrical body of the shock absorber (8).

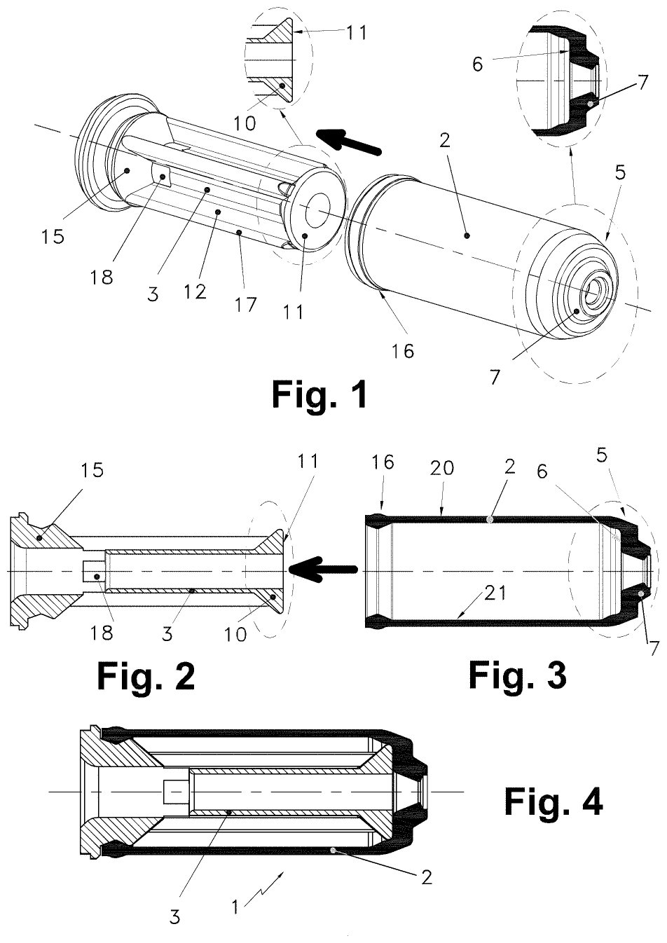

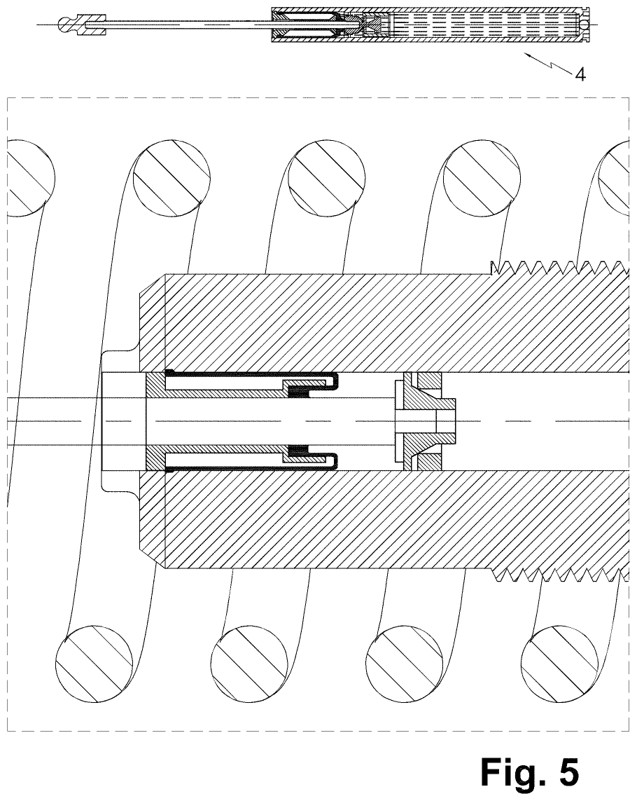

Thus, as can be seen in FIG. 1 and in FIGS. 2 and 3, during assembly the insertable elastic hood (2) is inserted into the centering tubular inner core (3), said cylindrical diaphragm assembly (1) being fixed in a simple manner and without the need for additional elements to achieve the compensation of the fluid displaced by the axis of the shock absorber (9), nor the need for additional elements to achieve the tightness between both chambers (13 and 14).

Once the diaphragm assembly is assembled (FIG. 4), it is inserted into the cylinder body of the shock absorber (4) with the axis of the shock absorber (9) inside the cylindrical diaphragm assembly (1). Thus, said insertable elastic hood (2) that has an annular decrease in diameter, ends in a conical extension of a simple seal (7), which allows manufacturing for reduced diameters that with other existing configurations would not be possible due to the difficulty in manufacturing and assembly due to the use of inward folds or double lip configurations. In this manner, a simple seal of the diaphragm assembly (1) is achieved with the axis of the shock absorber (9) preventing the entry of fluid into the aerial chamber (14) without the use of additional seals.

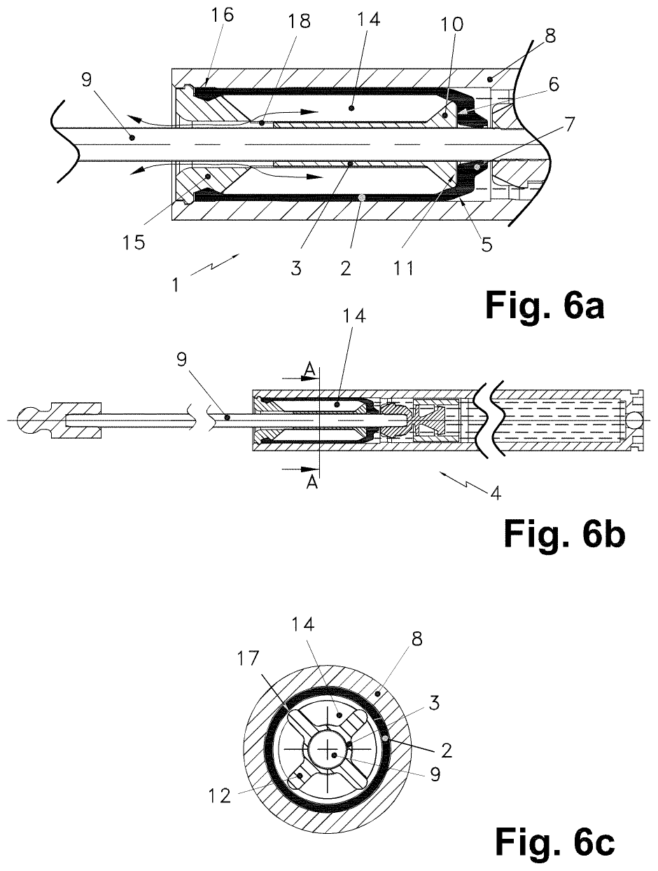

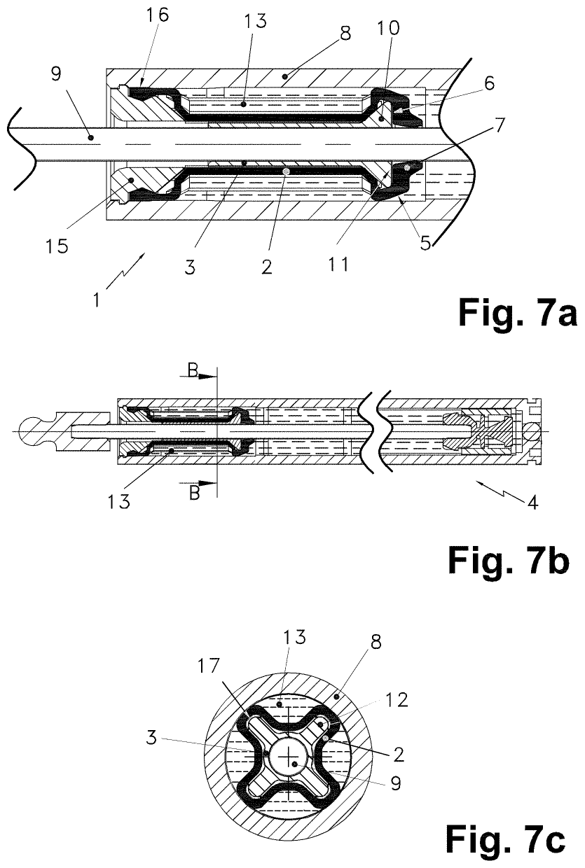

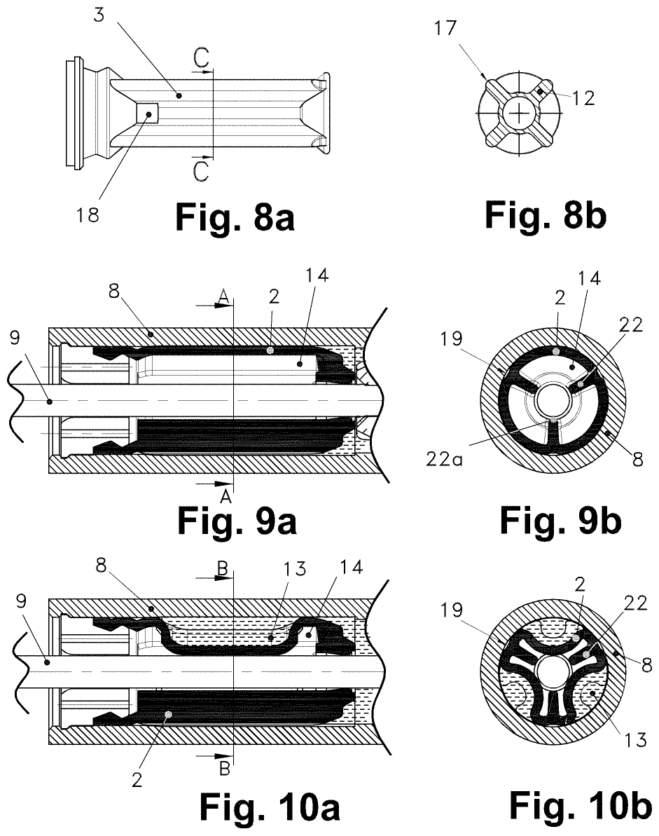

In the damping process, in its initial state of rest, before the introduction of the shock absorber shaft (9) the cylindrical diaphragm assembly (1) would be as shown in FIGS. 6a, 6b and 6c. Then, with the introduction of the shock absorber shaft (9) into the cylindrical body of the shock absorber for the actuation of the piston, compensation of the fluid displaced by said shock absorber shaft (9) is necessary. Thus, thanks to the cylindrical diaphragm assembly (1) this volume is compensated by the aerial chamber (14), said cylindrical diaphragm assembly (1) being in its active form as can be seen in FIGS. 7a, 7b and 7c. In these figures, we can see that at the inner end of the diaphragm assembly corresponding to the area deeper into the cylindrical body of the shock absorber (4), specifically at the inner end (5) of the insertable elastic hood (2), thanks to the configuration of flat wall of outer support and fixation (11) of the inner tubular centering male (3), its position is fixed with the flat support area (6) of said insertable elastic hood (2). In this manner, one can avoid said insertable elastic hood (2) moving and causing poor compensation during compression, resulting in ineffective damping.

Thus, thanks to the inner tubular centering male (3) the insertable elastic hood (2) is fixed and centered within the cylindrical body of the shock absorber (4) and as can be seen in FIG. 7c, said insertable elastic hood (2) adapts to the shape of the centering tubular inner core (3) which, together with the longitudinal flaps (12), results in a uniform deformation of the insertable elastic hood (2), achieving a controlled compensation and without generating critical fatigue zones. Furthermore, said longitudinal flaps (12) provide greater resistance to the cylindrical diaphragm assembly (1) and consequently providing greater durability and reliability.

Additionally, to achieve a softer deformation if possible and avoiding critical edges that can cause the diaphragm to break, as can be seen in FIGS. 6c and 7c, the top (17) of the longitudinal flaps (12) is rounded.

And in order for the deformation of the insertable elastic hood (2) to be uniform, it is expected that the distribution of the longitudinal flaps (12) of the centering tubular inner core (3) be peripherally symmetrical.

As can be seen in FIG. 1, another characteristic of the cylindrical diaphragm assembly (1) is that there are windows (18) in the tubular part of the outer end (closest to the closure plug) that allow the air contained in the inside of the aerial chamber (14) to be evacuated through said windows of atmospheric communication with the outside (18) (FIG. 6a), so that despite the decrease in volume of said aerial chamber (14), the pressure on the inner annular surface (21) of the insertable elastic hood (2) does not increase, avoiding antagonistic efforts acting against the insertion maneuver of the shock absorber shaft (9) into the shock absorber's cylindrical body (8).

In FIG. 9b, the longitudinal evacuation striations (19) can also be observed, in the contour of the outer annular surface (20), which facilitate the assembly of the shock absorber (4), evacuating the air existing in the cylindrical body of the shock absorber (8) and avoiding the creation of air pockets in the fluid housing area.

In an alternative embodiment, as can be seen in FIGS. 9b and 10b, which show the cross sections A-A and B-B indicated in FIGS. 9a and 10a respectively, the positioning ribs (22) emerging from the internal annular surface (21) of the insertable elastic hood (2) can be observed. These positioning ribs (22) guarantee the correct functioning of the aerial chamber (2), balancing the amount of fluid admitted between its outer annular surface (20) and the inner surface of the cylindrical body of the shock absorber (8), and avoiding displacements of the internal end (5) of the insertable elastic hood (2) during operation of the shock absorber (4).

Variations in materials, shape, size and arrangement of the component elements do not alter the essence of the invention, these being described in a non-limiting manner and being sufficient to proceed to their reproduction by an expert.

1. A cylindrical diaphragm assembly of reduced diameter for hydraulic shock absorbers with sealing at both ends, of those used in self-closing furniture, which at its outer end performs the sealing of the cylindrical body of the shock absorber and at its internal end performs sealing of the shock absorber shaft, said cylindrical diaphragm assembly being a fluid compensation chamber on its outer side and on the other inner side an aerial chamber wherein it is composed of an insertable elastic hood whose inner end has an annular decrease in diameter, generating a flat support area and ending in a conical extension of a simple seal in contact with the axis of the shock absorber, and of an inner tubular centering male provided at its inner end with a conical head with a flat wall for external support and fixing of said insertable elastic hood; and that said inner tubular centering male has longitudinal flaps ending said inner tubular centering male in a closure plug prominence which, with the outer end of the insertable elastic hood, generates a simple seal with the cylindrical body of the shock absorber.

2. The cylindrical diaphragm assembly for reduced sealing diameters at its two ends, according to claim 1, wherein the top of the longitudinal flaps of the centering tubular inner core is rounded.

3. The cylindrical diaphragm assembly for reduced sealing diameters at its two ends, according to claim 1, wherein the longitudinal flaps are peripherally symmetrical in distribution.

4. The cylindrical diaphragm assembly for reduced sealing diameters at its two ends, according to claim 1, wherein at least one atmospheric communication window with the outside exists in the tubular part of the outer end of the centering tubular inner male.

5. (canceled)

6. The cylindrical diaphragm assembly for reduced sealing diameters at its two ends, according to claim 1, wherein the insertable elastic hood, on its inner annular surface, incorporates ribs of circularly symmetrical positioning extended radially to the shock absorber shaft and with its end close to the surface of the shock absorber shaft.
